(19) United States
(12) Patent Application Publication
(10) Pub. No.: US 2004/0186789 A1
(43) Pub. Date: Sep. 23, 2004

(54) Method of and apparatus for providing group purchasing service, and computer product

(75) Inventor: Kenji Nakashima, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/764,523

(22) Filed: Jan. 27, 2004

(30) Foreign Application Priority Data
Feb. 5, 2003 (JP) 2003-028732

(51) Int. Cl. G06F 17/60

(52) U.S. Cl. 705/26

(57) ABSTRACT

When a group purchasing application according to a group of a predetermined number of persons is received, a group purchasing key that identifies the group is issued. When a product purchasing procedure request having the group purchasing key is received from a user, a payment processing is carried out at a normal price without a discount, and a product shipping processing is carried out. After the purchasing procedure processing for all users in the group is completed, a discount amount according to the group purchasing is calculated, and a discount amount payback processing is carried out.

### BACKGROUND OF THE INVENTION

1) Field of the Invention

The present invention relates to a method of and an apparatus for providing group purchasing service that provide an efficient group purchasing service particularly to purchasers who want to come by a product at an early date.

2) Description of the Related Art

Conventionally, a group purchasing system enables a plurality of purchasers to make a collective application for purchasing of a product of the same kind, and to receive a price discount at the time of purchasing the product. The group purchasing system gathers the purchasers in advance, and gives the price discount to the purchasers when the purchasers make a package deal contract with a dealer for purchasing a product.

For example, Japanese Patent Application Laid-open No. 2002-215998) discloses a price discount method for group purchasing that is designed to receive a product purchasing application from a plurality of purchasers via the Internet within a predetermined period, and set a higher price discount rate when the number of applicants for purchasing the product becomes larger.

According to the conventional group purchasing system, the purchasers cannot obtain the product until the package deal contract of the product is completed. Therefore, purchasers who want to come by a product at an early date cannot participate in the group purchasing.

In other words, according to the conventional group purchasing system, the number of purchasers is not determined until the purchasing application period has passed. Since a price discount rate is determined for the corresponding number of purchasers, the package deal contract is not completed earlier, and as a result, the purchasers cannot obtain the product earlier.

In order to satisfy the need of purchasers who want to come by a product at an early date, the purchasing application period must be shortened. However, when the purchasing application period is shortened, the number of purchasing applications for product decreases. Consequently, each purchaser cannot obtain the product at a high discount rate. From a viewpoint of dealers, shortening of the purchasing application period decreases their revenue due to a reduction in the number of products sold, thereby making it difficult to shorten the purchasing application period.

As explained above, according to the conventional group purchasing system, the product acquisition timing and the discount rate are in a trade-off relation. Therefore, purchasers who want to obtain a product at an early date have to purchase the product at a normal price in place of getting a discount from the group purchasing.

### SUMMARY OF THE INVENTION

It is an object of the present invention to solve at least the problems in the conventional technology.

The apparatus for providing a group purchasing service, according to one aspect of the present invention includes an identification information issuing unit that issues, upon receiving a group purchasing application request for a product from a user terminal, user identification information corresponding to the group purchasing application request, and a product purchasing execution unit that executes, upon receiving a purchasing procedure request for a product from the user terminal with the user identification information issued, a product purchasing procedure for a user who made the purchasing procedure request, and sets the user as an object user for the group purchasing processing corresponding to the user identification information.

The method for providing a group purchasing service, according to another aspect of the present invention includes receiving a group purchasing application request for a product from a user terminal, issuing user identification information corresponding to the group purchasing application request, receiving a purchasing procedure request for a product from the user terminal with the user identification information issued, executing a product purchasing procedure for a user who made the purchasing procedure request, and setting the user as an object user for the group purchasing processing corresponding to the user identification information.

The computer-readable recording medium according to still another aspect of the present invention stores a computer program that realizes the method according to the present invention on a computer.

The other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 depicts a concept of a processing of an apparatus for providing a group purchasing service according to a first embodiment of the present invention;

FIG. 2 is a block diagram of the apparatus for providing a group purchasing service according to the first embodiment;

FIG. 3 is a table of an example of data structure of user data;

FIG. 4 is a table of an example of data structure of product data;

FIG. 5 is a table of an example of data structure of discount rate data;

FIG. 6 is a table of an example of data structure of group purchasing management data;

FIG. 7 is a table of an example of data structure of group data;

FIG. 8 is a block diagram of a hardware configuration of the apparatus for providing a group purchasing service according to the first embodiment;

FIG. 9 is a flowchart of a group purchasing key issue processing processed by an identification information issuing unit and a group purchasing management unit shown in FIG. 2;

FIG. 10 is a schematic diagram of an example of a display screen that is output to a user terminal to receive a group purchasing key issuing request;

FIG. 11 is a schematic diagram of an example of a display screen that is output to the user terminal to notify users of a group purchasing key;

FIG. 12 is a flowchart of a product purchasing procedure process by the group purchasing management unit, a product purchasing payment processing unit, and a shipping processing request unit shown in FIG. 2;

FIG. 13 is a schematic diagram of an example of a display screen that is output to the user terminal to receive a product purchasing procedure request;

FIG. 14 is a flowchart of a discount amount calculation process by the group purchasing management unit and a discount amount calculation unit shown in FIG. 2;

FIG. 15 depicts a concept of a transmission processing of a uniform resource locator (URL) of the last page displayed when the reception processing of a group purchasing application request according to a second embodiment of the present invention is completed;

FIG. 16 depicts a concept of a transmission processing of a URL of an exclusive group purchasing website according to a third embodiment of the present invention;

FIG. 17 is a block diagram of an apparatus for providing the group purchasing service according to the third embodiment;

FIG. 18 is a flowchart of a preparation process of an exclusive group purchasing website by the group purchasing management unit, the identification information issuing unit, and a group exclusive page preparation unit shown in FIG. 17; and

FIG. 19 is a schematic diagram of an example of a display screen for receiving the group purchasing application request at the time of assigning purchasers who carry out a group purchasing in advance.

### DETAILED DESCRIPTIONS

Exemplary embodiments of a method of and an apparatus for providing a group purchasing service according to the present invention are explained in detail below with reference to the accompanying drawings. In the present embodiments, the application of the present invention to the apparatus that operates on the World Wide Web (WWW) as one distributed processing system on the Internet is explained.

In a first embodiment of the present invention, utilization of a group purchasing key as identification information to identify a group purchasing is explained. In a second embodiment of the present invention, utilization of a URL of the last page displayed when the reception processing of a group purchasing application request is completed, as identification information is explained. In a third embodiment of the present invention, preparation of an exclusive group purchasing website for a group purchasing and utilization of the URL as identification information are explained. In a fourth embodiment of the present invention, assignment of purchasers who carry out a group purchasing in advance and the identification of a group purchasing belong to the purchasers when the purchasers access the website are explained. Finally, other embodiments and effects of the present invention are explained.

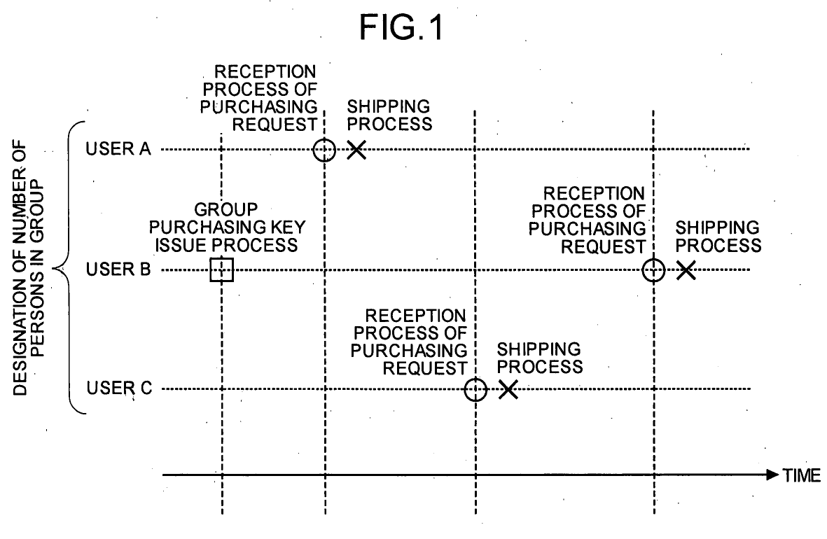

FIG. 1 depicts a concept of a processing of an apparatus for providing a group purchasing service according to a first embodiment of the present invention. The group purchasing service providing apparatus provides a group purchasing service that gives a price discount to a group of a plurality of purchasers (hereinafter, “users”). Three users are designated as a group in FIG. 1, however the number may be optional. The users do not need to purchase the same product for the group purchasing.

In this processing, when the apparatus receives a group purchasing application from one user (user B in this case) in the purchasing group, the apparatus issues a group purchasing key as identification information to identify the group purchasing. The apparatus also issues an expiration date of the group purchasing key. By suitably setting the expiration date, it is possible to urge the users to purchase a product at an early time.

The user B who obtains the information about the group purchasing key and the expiration date informs the other users (user A and user C) of the group purchasing key and the expiration date by using communication means such as e-mail.

The apparatus can receive a product purchasing procedure request from the users at any time within the expiration date of the group purchasing key. When the apparatus receives the product purchasing procedure request, the apparatus carries out a payment processing, and the users can obtain the product. Then, the apparatus carries out a product shipping processing.

At the time of payment, the users purchase the product temporarily at a normal price without a discount. The apparatus achieves the discount of the purchasing price by carrying out a payback processing after executing the reception processing of the product purchasing procedure requests from all the users (users, A, B, and C). The apparatus can execute the payback processing any time after taking the reception processing of the product purchasing procedure requests from all the users, even if the expiration date of the group purchasing key does not pass.

As explained above, in the group purchasing service according to the group purchasing service providing apparatus, the apparatus can provide the product to the users who carry out the purchasing procedure, at an early time and at a discount price, even if not all the users carry out the product purchasing procedure yet. As the users do not need to purchase the same product in the group purchasing, this method has an advantage in that users who participate in the group purchasing can be collected easily.

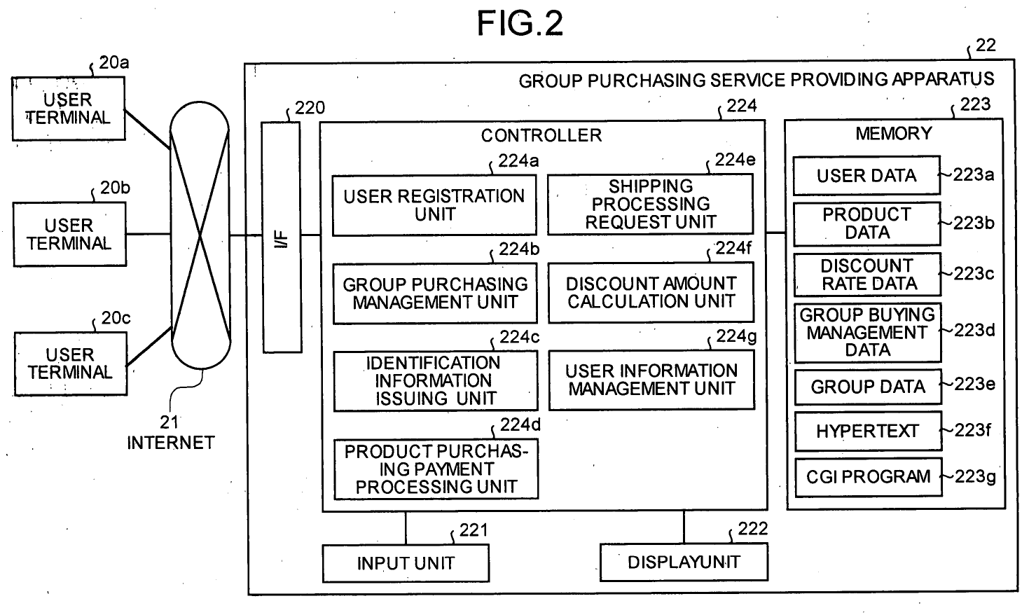

FIG. 2 is a block diagram of the apparatus for providing a group purchasing service according to the first embodiment. The group purchasing service providing system includes user terminal 20a to 20c, each connected to a group purchasing service providing apparatus 22 via the Internet 21.

The user terminal 20a to 20c are Internet terminals each having a web browser installed to be accessible to a hyper text transfer protocol (HTTP) server. The user terminal 20a to 20c can access various server apparatuses on the Internet, via a provider or the like.

The group purchasing service providing apparatus 22 according to the present invention is an HTTP server that receives access from the user terminal 20a to 20c on the Internet, and provides a web service concerning the group purchasing.

Specifically, unlike the conventional technique of collectively carrying out the payment and shipping of the product purchasing after ending a predetermined application period, the payment and shipping of the product purchasing are carried out when the product purchasing procedure request is received. With this arrangement, the product can be quickly provided to the users.

As shown in FIG. 2, the group purchasing service providing apparatus 22 includes an interface unit 220, an input unit 221, a display unit 222, a memory unit 223, and a control unit 224. The interface unit 220 is a network interface that exchanges data with the user terminal 20a to 20c via the Internet 21. Specifically, the interface unit 220 carries out the processing according to a protocol of the TCP/IP.

The input unit 221 includes a keyboard or a mouse or the like. The display unit 222 includes a liquid crystal panel or a display or the like. The memory unit 223 is a hard disk device or the like.

The memory unit 223 stores user data 223a, product data 223b, discount rate data 223c, group purchasing management data 223d, group data 223e, a hypertext 223f, and a common gateway interface (CGI) program 223g.

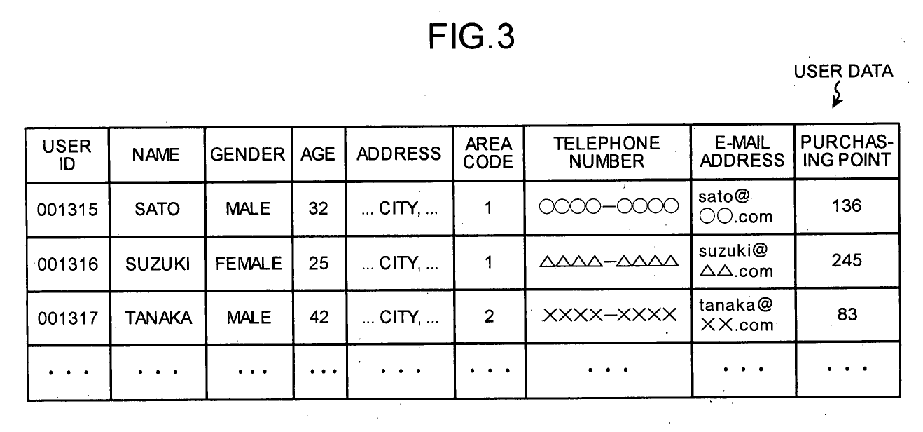

FIG. 3 to FIG. 7 are tables of examples of the data structures of the user data 223a, the product data 223b, the discount rate data 223c, the group purchasing management data 223d, and the group data 223e, respectively.

The user data 223a stores individual information of users who utilize the group purchasing. Specifically, as shown in FIG. 3, the user data 223a stores a user ID, name, gender, age, address, area code that identifies a local area of the address, telephone number, e-mail address, and credit points that can be used for a discount of the product and exchange of the product, for each user.

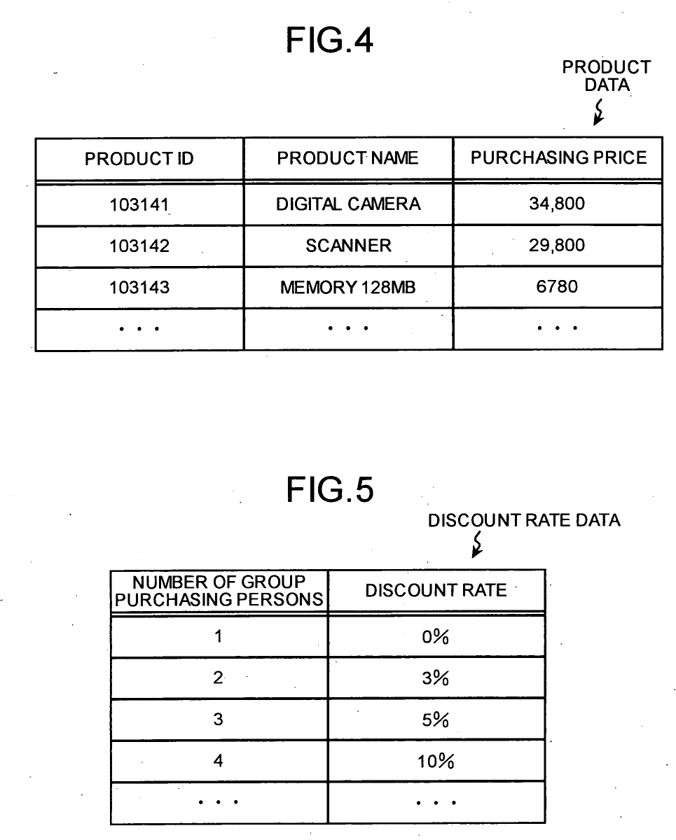

The product data 223b stores products that are bought by the group purchasing. Specifically, as shown in FIG. 4, the product data 223b stores a product ID, a product name, and a normal purchasing price of the product without a discount, for each product.

The discount rate data 223c stores a relationship between a number of group purchasing persons and a discount rate applied to the discount of the purchasing price. As shown in FIG. 5, a higher discount rate is applied when the number of persons in the group purchasing increases. Based on this setting, a dealer that provides the group purchasing service can urge many users to participate in the group purchasing thereby to promote the selling.

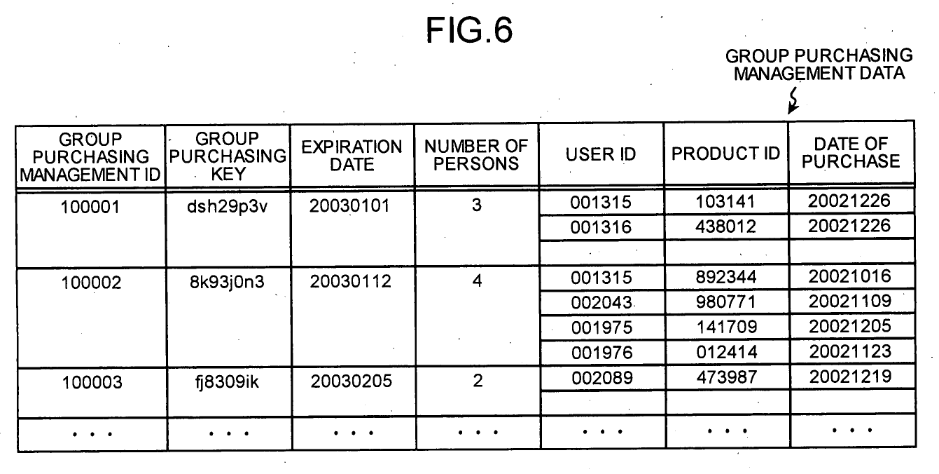

The group purchasing management data 223d is used to manage information concerning the group purchasing. Specifically, as shown in FIG. 6, the group purchasing management data 223d stores a group purchasing management ID as a serial number of the accepted group purchasing, a group purchasing key that identifies each group purchasing, an expiration date of the group purchasing key, a number of persons who participate in the group purchasing, a user ID of a user who already ends the product purchasing procedure in the group purchasing, a purchasing product ID of the product that the user already purchased, and a purchase date when the user purchases the product.

The group purchasing key is issued with numerals and alphabet combined together in complex to avoid a third party from easily finding out the group purchasing key and accessing the key illegally. Blanks in the user ID, the purchasing product ID, and the purchase date are portions where information of users who have not yet carried out the product purchasing procedure request are written after the procedure request, among the group purchasing participants.

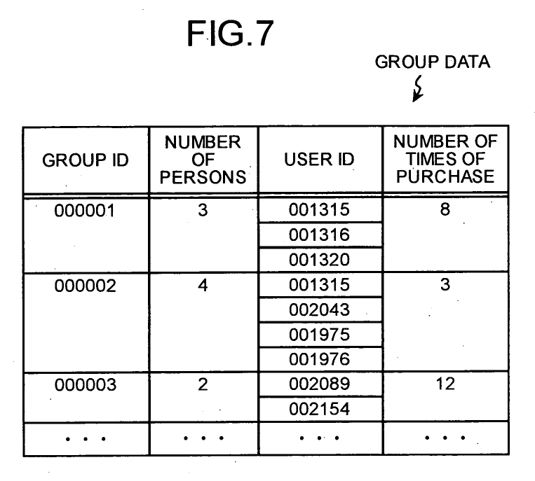

The group data 223e stores user information of the group who carried out the group purchasing in the past. Specifically, as shown in FIG. 7, the group data 223e stores a group ID that is allocated to the group, the number of persons who belong to the group, a user ID of each user, and the number of times of group purchasing.

In the group purchasing, a group purchasing application is carried out after users who participate in the group purchasing are invited. Therefore, the users who participate in the group purchasing might know each other, and have a high possibility to participate in the group purchasing with the same group again.

By referring to the group data 223e, when an advertisement of a group purchasing is notified by e-mail to a group of persons who carried out the group purchasing at a small number of times in the past, the sales promotion of the group purchasing can be further achieved.

The group data 223e may further store product IDs of products that each group bought at a large number of amount. Based on this, it is possible to understand a trend of product purchasing by each group. When a product similar to a product that a certain group bought at a large number of amounts is sold as a new product, an advertisement of a group purchasing concerning the product is sent by e-mail to the user terminal 20a to 20c of the users who belong to the group. With this arrangement, sales promotion can be carried out effectively.

Referring back to FIG. 2, the hypertext 223f structures a browser screen concerning a group purchasing that is distributed to the user terminal 20a to 20c. The CGI program 223g is designed to provide an interactive browser screen that is structured by the hypertext 223f. The CGI program 223g works to read input data transmitted from the web browsers of the user terminal 20a to 20c, and to create a browser screen according to the input from the user terminal 20a to 20c.

The control unit 224 controls the whole of the group purchasing service providing apparatus 22. The control unit 224 has a user registration unit 224a, a group purchasing management unit 224b, an identification information issuing unit 224c, a product purchasing payment processing unit 224d, a shipping processing request unit 224e, a discount amount calculation unit 224f, and a user information management unit 224g.

The user registration unit 224a stores individual information of users who carry out a product purchasing procedure request according to the group purchasing. Specifically, when receiving a user registration request from the user terminal 20a to 20c, the user registration unit 224a issues a user ID as a serial number that is given to each user. The user registration unit 224a receives individual information of each user including a name, an address, and an e-mail address of the user from each of the user terminal 20a to 20c, and stores the information as the user data 223a into the memory unit 223.

When receiving a group purchasing application from the user terminal 20a to 20c, the group purchasing management unit 224b registers the information concerning the group purchasing using the group purchasing key into the group purchasing management data 223d stored in the memory unit 223. When receiving a product purchasing procedure request from the user terminal 20a to 20c, the group purchasing management unit 224b registers the user IDs of the users who make the application, into the group purchasing management data 223d.

When receiving a group purchasing key issuing request from the user terminal 20a to 20c, the identification information issuing unit 224c issues a group purchasing key and an expiration date, and outputs the information to the user terminal 20a to 20c. (The identification information issuing unit 224c corresponds to an identification information transmitting unit and an expiration date preparing unit in the present invention.) When receiving a product purchasing procedure request from the user terminal 20a to 20c, the product purchasing payment processing unit 224d receives the group purchasing key, and carries out a payment processing concerning the purchase.

Specifically, the product purchasing payment processing unit 224d obtains a credit card number and a credit card expiration date from each of the user terminal 20a to 20c, and transmits these pieces of information and the product purchase amount to a server unit of a credit card company not shown.

The product purchase price is drawn from a bank account of the credit card based on the transmitted information, and is paid to the credit card company. Although the payment according to a credit card system is explained as a payment method, any other payment processing method may be used.

When the product purchasing payment processing is carried out, the shipping processing request unit 224e outputs a product shipping request to a terminal apparatus not shown of a shipping unit responsible for the shipping of the product.

The discount amount calculation unit 224f calculates a discount amount of the product concerning the group purchasing that is paid back to the user, by referring to the discount rate data 223c. The discount amount calculation unit 224f converts the calculated discount amount into a credit point, and registers the credit point into the user data 223a stored in the memory unit 223. The information concerning the discount amount and the credit point can be displayed on the display unit 222 when necessary, and can be transmitted to the user terminal 20a to 20c.

The dealer can allot the credit point to only be used at the own shop, and this has an advantage in collecting purchasers to the shop. Although the discount amount is paid back in terms of the credit point in this example the discount amount can also be paid back with cash vouchers, such as exchange coupons, or in cash.

When receiving product purchasing procedure requests from a plurality of users, the discount amount calculation unit 224f checks whether the user area codes are the same. When the user area codes are the same, the discount amount calculation unit 224f calculates a discount amount due to the same area. The discount amount is determined optionally, and can be used as a discount of the product shipping cost.

When the shipping area is limited, the shipping cost can be suppressed. Therefore, the merit of the discount is set for the users. When the users are given a further discount in addition to the discount due to the group purchasing, the users' desire to purchase products increases. This has an advantage in further promoting the selling. When the discount amount calculation unit 224f receives product purchasing procedure requests from a plurality of users of the same area codes during a certain period, the discount rate may be further increased.

When the reception processing of the purchasing procedure of all the users is not completed within the expiration date of the group purchasing key, the discount amount calculation unit 224F sets the discount amount for the users who already bought the product as “zero yen”. This is a penalty to a fact that users corresponding to the number of users set at the time of the group purchasing application did not carry out the purchasing procedure. In this case, the discount amount is not paid back, which means that the users purchase the product without a discount.

The user information management unit 224g extracts user IDs of users belonging to the group of persons who carried out the group purchasing, and the number of times when the group carried out the group purchasing from the group purchasing management data 223d stored in the memory unit 223. The user information management unit 224g stores these pieces of information as the group data 223e into the memory unit 223 (corresponding to the user information managing unit in the present invention). The user information management unit 224g transmits by e-mail an advertisement concerning the group purchasing to a group of persons who bought products at a small number of times.

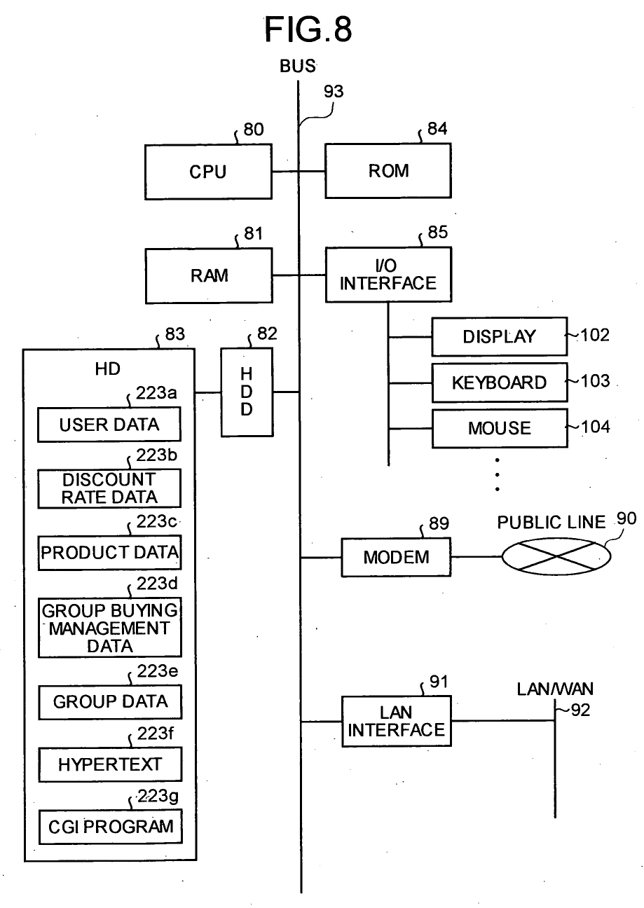

FIG. 8 is a block diagram of a hardware configuration of the apparatus for providing a group purchasing service according to the first embodiment. The group purchasing service providing apparatus 22 has a central processing unit (CPU) 80, a random access memory (RAM) 81, a hard disk drive (HDD) 82, a read only memory (ROM) 84, an I/O interface 85, a modem 89, and a local area network (LAN) interface 91 connected to each other via a bus 93. In other words, the group purchasing service providing apparatus 22 has a normal hardware configuration such as a personal computer and a workstation.

The CPU 80 controls a total system of the group purchasing service providing apparatus 22. The RAM 81 stores a program or the like according to the present invention that provides an operating system (OS) and a group purchasing service. The HDD 82 controls a storing of data into the hard disk (HD) 83 as a recording medium, and a reading of data from the HD 83.

The HD 83 stores the user data 223a, the discount rate data 223b, the product data 223c, the group purchasing management data 223d, the group data 223e, the hypertext 223f, and the CGI program 223g. The ROM 84 stores a boot program and the like in advance.

The I/O interface 85 connects a display 102, a keyboard 103, and a mouse 104 or the like. The modem 89 is used to connect the apparatus to a public line 90 like the Internet 21. The LAN interface 91 is used to connect the apparatus to a local area network and a wide area network (LAN/WAN) 92. The group purchasing service providing apparatus 22 is connected to the Internet via the public line 90 and various kinds of networks using the modem 89 and the LAN interface 91 so as to be able to carry out data communication with the user terminal 20a to 20c.

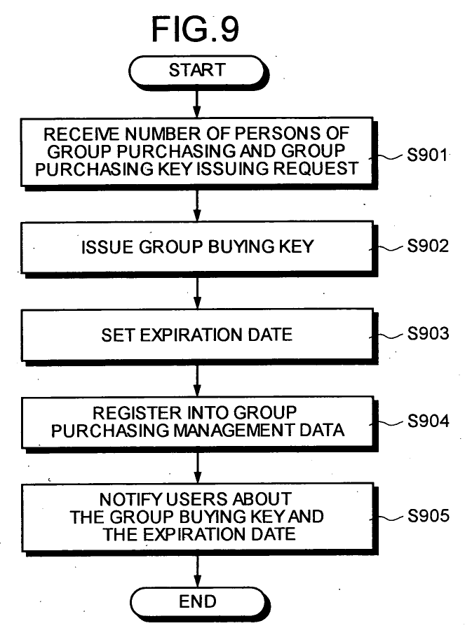

A processing procedure of a group purchasing key issue processing carried out by the group purchasing management unit 224b and the identification information issuing unit 224c shown in FIG. 2 will be explained. FIG. 9 is a flowchart of the processing procedure of a group purchasing key issue processing carried out by the group purchasing management unit 224b and the identification information issuing unit 224c shown in FIG. 2.

As shown in FIG. 9, the identification information issuing unit 224c first receives the information about the number of group persons who carry out the group purchasing and the group purchasing key issuing request to identify the group purchasing by the group, from the user terminal 20a to 20c of the users who carry out the group purchasing application (step S901). The identification information issuing unit 224c issues the group purchasing key according to the request (step S902), and sets the expiration date of the group purchasing key (step S903).

Next, the group purchasing management unit 224b registers the group purchasing management ID, the group purchasing key, the expiration date of the group purchasing key, and the number of the users who carry out the group purchasing, into the group purchasing management data 223d stored in the memory unit 223 (step S904). Then the identification information issuing unit 224c outputs the group purchasing key and the expiration date of the group purchasing key to the user terminal 20a to 20c of the users who transmit the group purchasing key issuing request, and notifies the information to the users (step S905). A user can carry out the group purchasing key issue processing shown in FIG. 9, by providing an exclusive page or by providing a button for the group purchasing key issue processing in the product purchasing page.

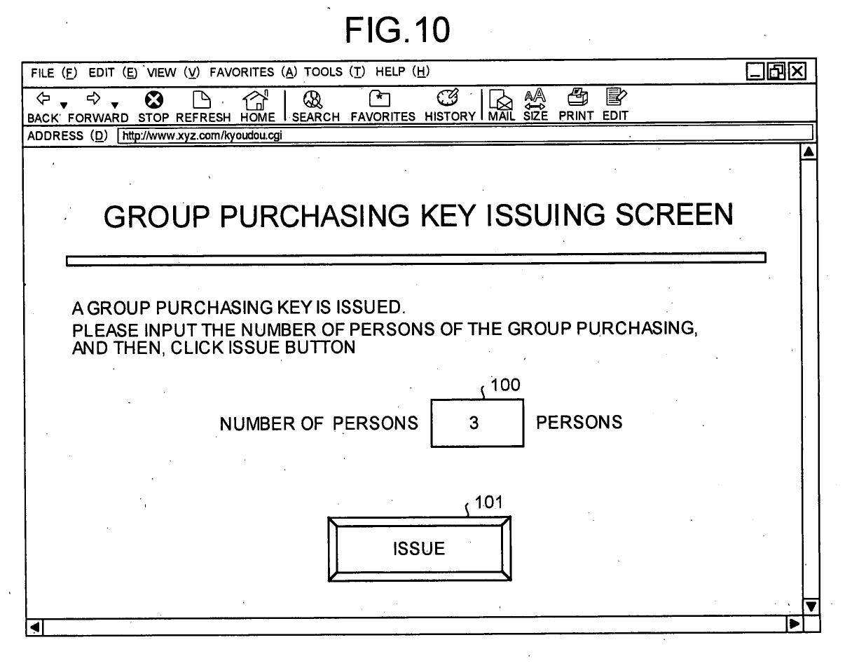

FIG. 10 is a schematic diagram of an example of a display screen that is output to the user terminal 20a to 20c to receive a group purchasing key issuing request. The screen displays an input form 100 in which a user can input the number of group persons who carry out the group purchasing, and an issue button 101 to request for the issue of the group purchasing key. The user inputs the number of persons into the input form 100, and clicks the issue button 101, thereby to easily request for the issue of the group purchasing key.

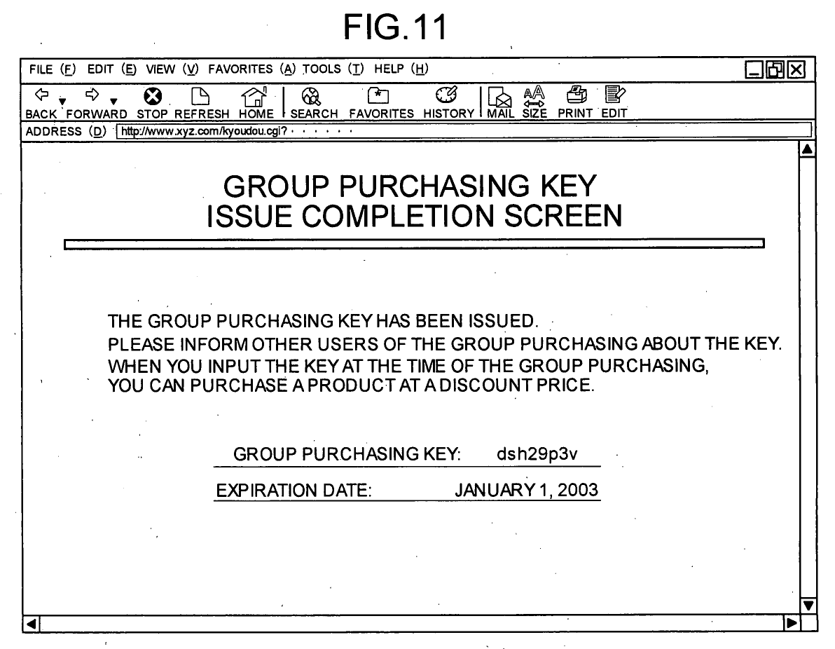

FIG. 11 is a schematic diagram of an example of a display screen that is output to the user terminal 20a to 20c to notify the users about the group purchasing key. The screen displays an issued group purchasing key “dsh29p3v”, and an expiration date “Jan. 1, 2003” of the group purchasing key. The user who receives the notification notifies the information to other users in the group by e-mail or the like.

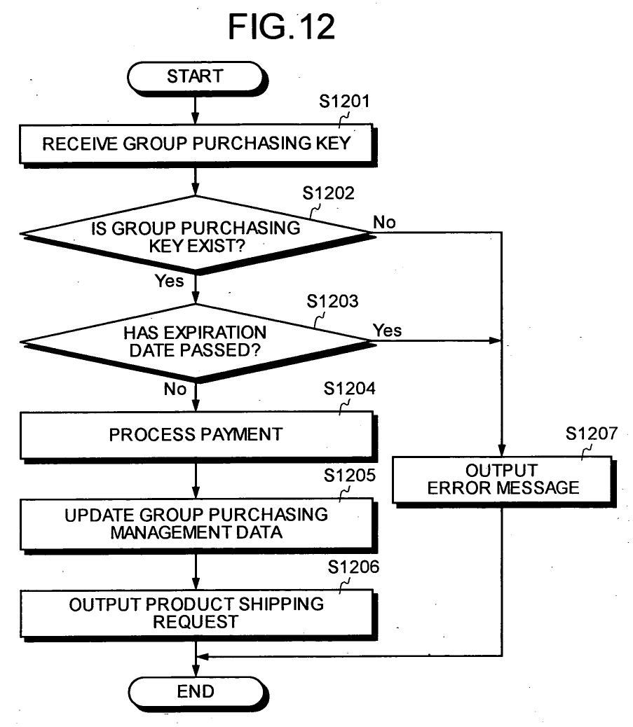

A processing procedure of the product purchasing procedure processing carried out by the group purchasing management unit 224b, the product purchasing payment processing unit 224d, and the shipping processing request unit 224e shown in FIG. 2 will be explained next. FIG. 12 is a flowchart of the product purchasing procedure processing carried out by the group purchasing management unit 224b, the product purchasing payment processing unit 224d, and the shipping processing request unit 224e shown in FIG. 2. It is assumed that the user has already ended the work of selecting a product to be purchased on the website page. It is also assumed that a user ID to identify the user is already input at the time of the product purchasing procedure.

As shown in FIG. 12, the product purchasing payment processing unit 224d first receives the group purchasing key from the user terminal 20a to 20c of the users who purchase the product (step S1201). The product purchasing payment processing unit 224d checks whether the group purchasing key is present in the group purchasing management data 223d (step S1202).

When the group purchasing key is not present in the group purchasing management data 223d (No at step S1202), the product purchasing payment processing unit 224d outputs an error message to notify the effect to the user terminal 20a to 20c (step S1207), and ends the processing.

When the group purchasing key is present in the group purchasing management data 223d (Yes at step S1202), the product purchasing payment processing unit 224d checks whether the expiration date of the group purchasing key has passed (step S1203). When the expiration date has passed (Yes at step S1203), the product purchasing payment processing unit 224d outputs an error message to notify the effect to the user terminal 20a to 20c (step S1207), and ends the processing.

When the expiration date of the group purchasing key has not passed (No at step S1203), the product purchasing payment processing unit 224d carries out the payment processing of the user product purchasing (step S1204). Then, the group purchasing management unit 224b updates the group purchasing management data 223d (step S1205). Specifically, the group purchasing management unit 224b registers the user ID of the user whose product payment processing is completed, the product ID of the product that is bought by the user, and the product purchase date. Then, the shipping processing request unit 224e outputs the product transmission request to the terminal apparatus of the shipping unit (step S1206), and ends the processing.

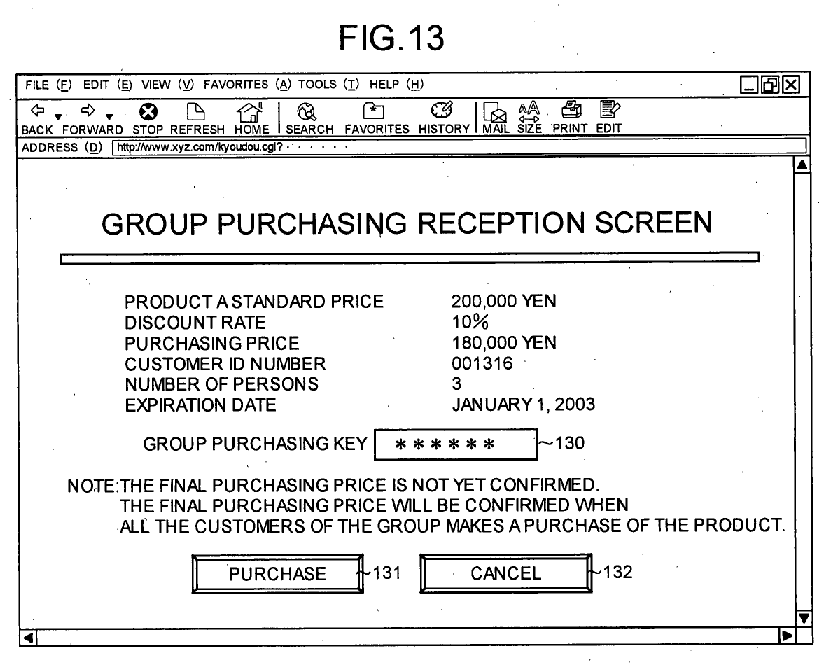

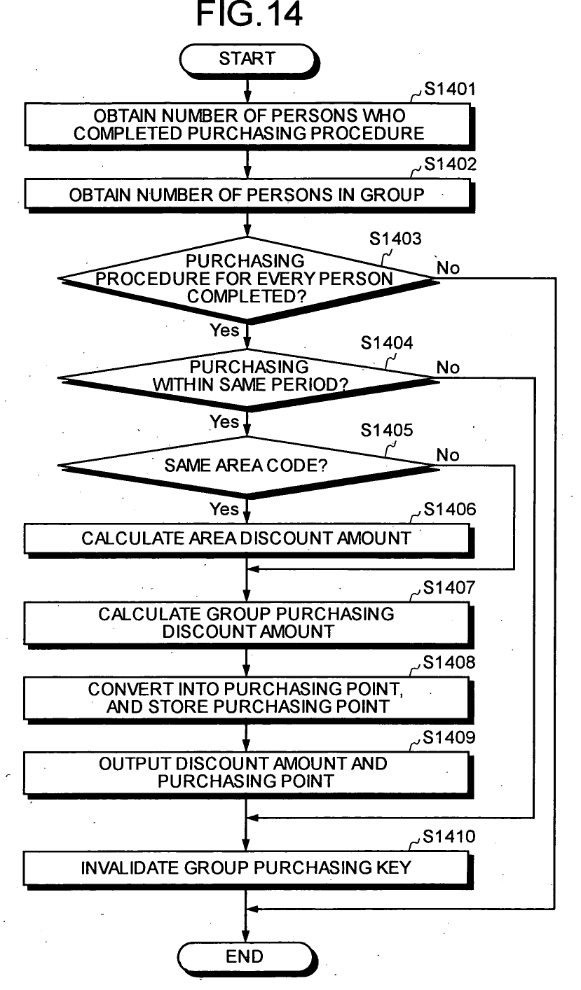

FIG. 13 is a schematic diagram of an example of a display screen that is output to the user terminal 20a to 20c to receive a product purchasing procedure request. The screen shows product information (product name and standard price) of the product that the user selects, information (discount rate, purchasing price, number of persons who purchase the product in the group, and expiration date of the group purchasing key) concerning the group purchasing, and information (user ID) of the user.

The screen further displays an input form 130 in which the user inputs the group purchasing key, a purchasing button 131 that is used to request for a start of the product purchasing procedure, and a cancellation button 132 that is used to cancel the purchasing. The user can utilize the display screen to easily make application for the product purchasing procedure.

A processing procedure of the discount amount calculation processing carried out by the group purchasing management unit 224b and the discount amount calculation unit 224f shown in FIG. 2 will be explained next. FIG. 14 is a flowchart of the discount amount calculation processing carried out by the group purchasing management unit 224b and the discount amount calculation unit 224f shown in FIG. 2. The discount amount calculation processing may be started, for example, at a predetermined time every day, or after the completion of the user purchasing procedure using the group purchasing key.

As shown in FIG. 14, the discount amount calculation unit 224f first obtains the number of users who completed the product purchasing procedure by referring to the group purchasing management data 223d (step S1401). The discount amount calculation unit 224f obtains the number of users who belong to the group from the group purchasing management data 223d (step S1402). The discount amount calculation unit 224f compares these numbers of the persons, thereby to check whether all the users belonging to the group completed the purchasing procedure (step S1403).

When all the users who belong to the group did not complete the purchasing procedure (No at step S1403), the discount amount calculation unit 224f ends the processing. When all the users completed the purchasing procedure (Yes at step S1403), the discount amount calculation unit 224f checks the user product purchase date by referring to the group purchasing management data 223d, and checks whether a plurality of users carried out the product purchasing procedure within the same period (step S1404).

When none of the users carried out the product purchasing procedure within the same period (No at step S1404), the process shifts to step S1410. When a plurality of users carried out the product purchasing procedure within the same period (Yes at step S1404), the discount amount calculation unit 224f checks whether the area codes of these users are the same by referring to the user data 223a (step S1405).

When the area codes of these users are different (No at step S1405), the process shifts to step S1407. When there are a plurality of users whose area codes are the same (Yes at step S1405), the discount amount calculation unit 224f calculates the discount amount for these users due to the same shipping area (step S1406).

Next, the discount amount calculation unit 224f obtains a discount rate corresponding to the number of persons who carried out the group purchasing within the same period by referring to the discount rate data 223c stored in the memory unit 223, and calculates the discount amount due to the group purchasing (step S1407). The discount amount calculation unit 224f converts a total discount amount into a credit point, and stores the credit point into the user data 223a (step S1408).

The calculated discount amount and credit point are output to the user terminal 20a to 20c, and are notified to the users (step S1409). Finally, the group purchasing management unit 224b deletes the group purchasing key from the group purchasing management data 223d to make it invalid (step S1410), and ends the processing.

In the present embodiment, at step S1404, when a plurality of users out of the number of persons assigned at the group purchasing key issuing time carried out the product group purchasing procedure within the expiration date of the group purchasing, the discount amount is carried out for the users who already carried out the product purchasing procedure.

However, the process is not limited to the above in the present invention. When the product purchasing procedure is not carried out, at step S1404, for the number of persons who are assigned at the group purchasing key issuing time within the expiration date of the group purchasing, the process may shift to step S1410 to delete the group purchasing key to make it invalid, without carrying out the discount processing.

In the present embodiment, at step S1403, the process shifts to the discount calculation processing due to the group purchasing when the completion of the purchasing procedure of all the users is determined. In stead of this processing, the process may shift to the calculation processing after determining that the current date has passed the expiration date of the group purchasing.

As described above, according to the first embodiment, the group purchasing key is issued to identify the group purchasing of a group. When the apparatus receives the product purchasing procedure application from the user who belongs to the group that is identified by the group purchasing key, the apparatus carries out the payment processing and the product transmission request. After completing the purchasing procedure of all the users, the apparatus calculates the discount amount and carries out the pay back processing. Therefore, the group purchasing service capable of enabling the users to quickly obtain the product and obtain the discount merit can be provided efficiently.

In the first embodiment, the group purchasing of a group is carried out by issuing the group purchasing key. When the apparatus receives the group purchasing key from the user terminal, the apparatus carries out the product purchasing procedure for the users who belong to the group. However, the present invention is not limited to this method. Identification information other than the group purchasing key can also be applied to the present invention.

In the second embodiment, the utilization of a URL of the last page displayed when the reception processing of the group purchasing application request is completed, as the identification information is explained.

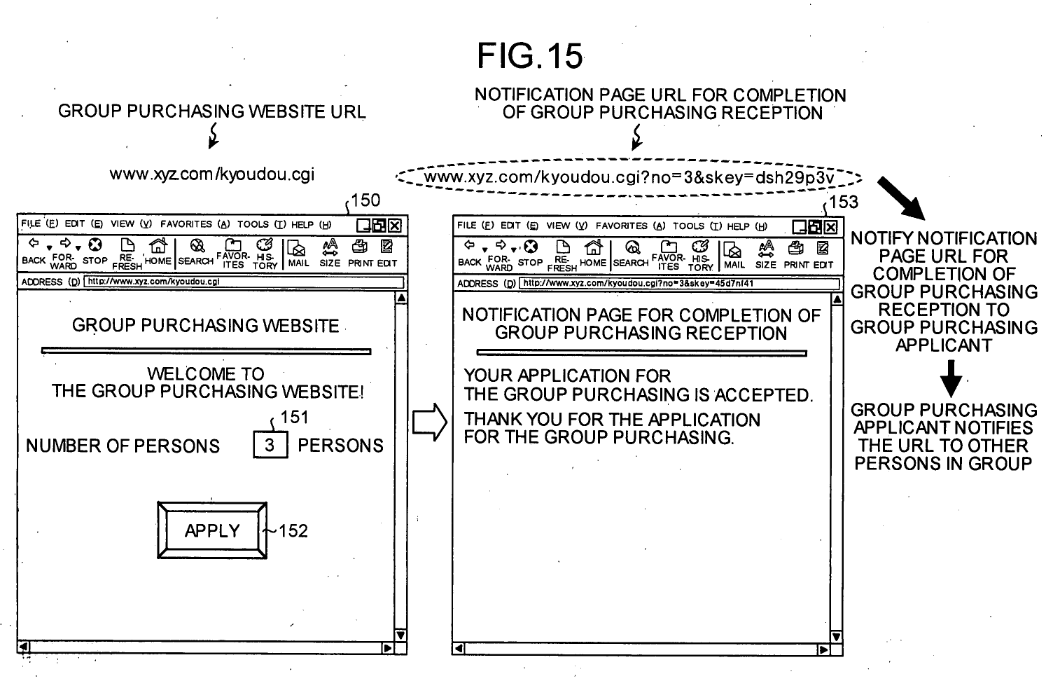

First, a concept of a transmission processing of the URL of the last page that is displayed when the reception processing of the group purchasing application request according to the second embodiment of the present invention is completed, will be explained. FIG. 15 depicts a concept of a transmission processing of a uniform resource locator (URL) of the last page displayed when the reception processing of a group purchasing application request according to a second embodiment of the present invention is completed.

The group purchasing service providing apparatus according to the second embodiment receives the group purchasing application that is carried out by one of persons who carry out the group purchasing on a group purchasing website 150. The person inputs the number of persons who carry out the group purchasing, into an input form 151, and clicks an application button 152.

When the apparatus receives the group purchasing application request, the apparatus outputs a reception completion notification page for group purchasing applications 153 (i.e. the last page of the reception of the group purchasing application) that expresses the completion of the reception, to the user terminal apparatus of the user who carries out the group purchasing application request.

The reception completion notification page for group purchasing applications 153 is created by using a CGI program (kyoudou.cgi). In this case, the apparatus issues identification information (dsh29p3v) that identifies the group purchasing by the group, and embeds this information into the URL “www,xyz.com/kyoudou.cgi?no=3&skey=dsh29p3v” on the reception completion notification page for group purchasing applications 153.

The URL “www,xyz.com/kyoudou.cgi” represents the URL of the group purchasing website for general users, and is given according to a CGI program of “group.cgi”.

“no=3” and “skey=dsh29p3v” are arguments that are delivered to the CGI program. In this example, these arguments mean identification information that identifies the number of group purchasing persons, and information that identifies the group purchasing by the group respectively.

The user who carries out the group purchasing application obtains the URL of the reception completion notification page for group purchasing applications 153, as the identification information, and notifies this information to other users in the group by e-mail or the like.

To carry out the product purchasing procedure, the user transmits the URL of the reception completion notification page for group purchasing applications 153 together with the purchasing procedure request, to the apparatus. Then, the apparatus receives the URL, and specifies the group purchasing of the group to which the user who carries out the purchasing procedure request belongs. As a result, the persons belonging to the group can carry out the purchasing procedure.

A configuration of the group purchasing service providing apparatus according to the second embodiment will be explained next. The configuration of the group purchasing service providing apparatus according to the second embodiment is substantially similar to the configuration shown in FIG. 2. A difference between the two configurations is explained with reference to the functional block diagram of the configuration of the group purchasing service providing apparatus shown in FIG. 2.

In the group purchasing service providing apparatus 22 according to the second embodiment, the identification information issuing unit 224c issues the URL of the reception completion notification page for group purchasing applications 153 as the identification information. Specifically, the group purchasing service providing apparatus 22 obtains the URL of the reception completion notification page for group purchasing applications 153 created by the CGI program 223g, and issues the URL as the identification information. The apparatus also creates the expiration date of the URL.

When the user terminal 20a to 20c transmit the product purchasing procedure request together with the URL of the reception completion notification page for group purchasing applications 153, the product purchasing payment processing unit 224d receives the URL, specifies the group purchasing of the group to which the users belong, confirms the expiration date of the URL, and carries out the payment processing of the product purchasing.

As described above, according to the second embodiment, the apparatus receives the group purchasing application together with the number of persons in the group who participate in the group purchasing. The apparatus issues the URL of the reception completion notification page for group purchasing applications 153 displayed when the reception processing is completed, as the identification information. Therefore, by only making the group purchasing application, the users can easily obtain the identification information of the group purchasing that is necessary to carry out the product purchasing procedure.

In the second embodiment, the URL of the last page displayed when the reception processing of the group purchasing application request is completed, is used as the identification information. It is also possible to utilize, as the identification information, the URL of the last page displayed when the product purchasing procedure for the users who carry out the group purchasing is completed.

In the second embodiment, the URL of the last page displayed when the reception processing of the group purchasing application request is completed, is used as the identification information. It is also possible to create an exclusive website for the group of persons who carry out the product purchasing procedure based on a group purchasing when the apparatus receives the group purchasing application request. The URL of the website can be utilized as the identification information that identifies the group purchasing by the group.

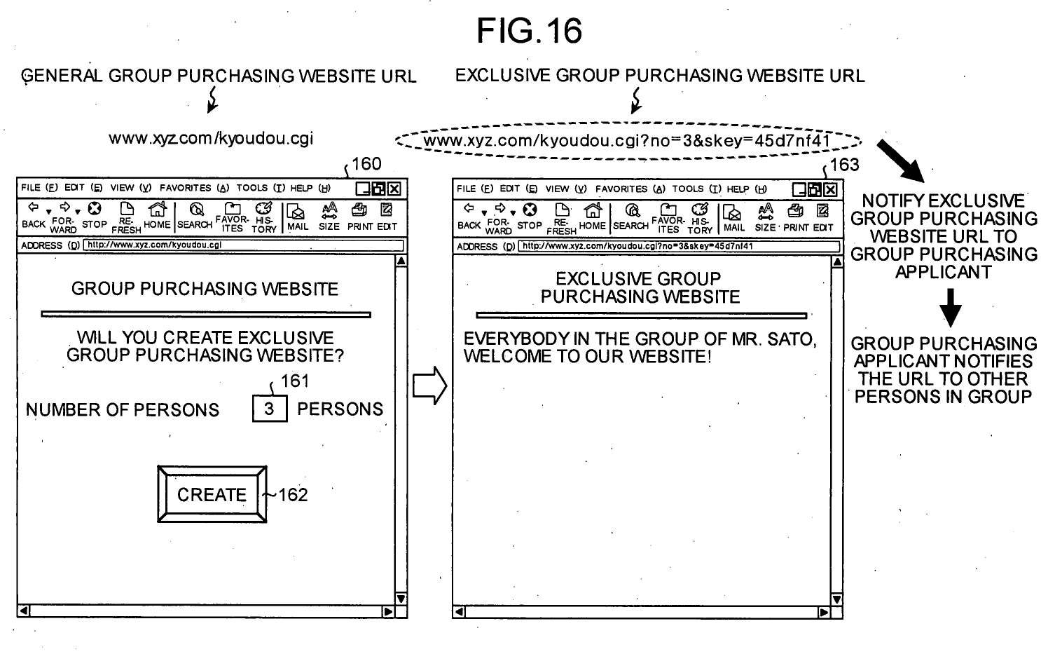

FIG. 16 depicts a concept of a transmission processing of a URL of an exclusive group purchasing website according to a third embodiment of the present invention. The group purchasing service providing apparatus according to the third embodiment outputs a general group purchasing website 160 to a user terminal apparatus. The group purchasing service providing apparatus receives from the user terminal apparatus a request for preparing an exclusive group purchasing website 163 that enables only the users within the group to carry out the product purchasing procedure according to the group purchasing.

The general group purchasing website 160 has an input form 161 that is used to receive an input of the number of users within the group who carry out the group purchasing, and a preparation button 162 that is used to transmit the request for preparing the exclusive group purchasing website 163.

Upon receiving the request for preparing the exclusive group purchasing website 163, the group purchasing service providing apparatus creates the exclusive group purchasing website 163 and the expiration date of a URL “www.xyz.com/group.cgi?no=3&group key=45d7nf41” of the website.

The group purchasing service providing apparatus transmits and notifies the URL of the exclusive group purchasing website 153, and the expiration date of the URL to the user terminal apparatus of the user who transmits the website preparation request.

The URL “www.xyz.com/group.cgi” represents the URL of the group purchasing website for general users, and indicates that the website is created by a CGI program of “group.cgi”.

“no=3” and “group_key=45d7nf41”“are arguments that are delivered to the CGI program. In this example, these arguments mean group keys to identify the number of group purchasing persons and the group.

The group key “45d7nf41” is issued to set the URL with numerals and alphabet combined together in complex to avoid a third party from easily finding out the group key and accessing the key illegally.

A user receives the notification of the URL of the exclusive group purchasing website 163, and the expiration date of the URL, and notifies these pieces of information to other users in the group by e-mail or the like. The users input the notified URL to the web browser to carry out the product purchasing procedure. With this arrangement, the exclusive group purchasing website 163 that only the users who belong to the group can access is displayed to carry out the purchasing procedure.

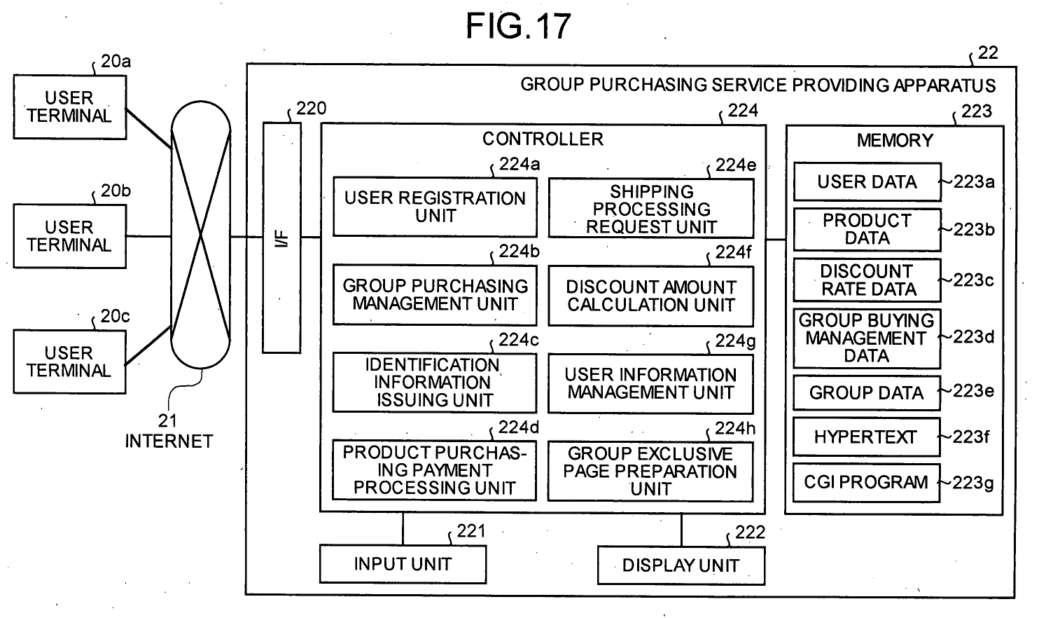

A configuration of the group purchasing service providing apparatus according to the third embodiment will be explained next. FIG. 17 is a block diagram of the group purchasing service providing apparatus according to the third embodiment. Parts of the group purchasing service providing apparatus shown in FIG. 2 are designated with the same reference numerals, and their detailed explanation is omitted.

The configuration of the third embodiment is different from that according to the first embodiment shown in FIG. 2 in that the control unit 224 of the group purchasing service providing apparatus 22 has a group exclusive page preparation unit 224h.

In the third embodiment, the identification information issuing unit 224c receives the request for preparing the exclusive group purchasing website 163 transmitted from the user terminal 20a to 20c, and issues the URL that is allocated to the exclusive group purchasing website 163.

Specifically, the identification information issuing unit 224c obtains the URL of the exclusive group purchasing website 163 created by the group exclusive page preparation unit 224h shown later, and issues the URL as the identification information. The identification information issuing unit 224c also creates the expiration date of the URL at the same time.

The group purchasing management unit 224b registers the issued URL and expiration date into the group purchasing management data 223d stored in the memory unit 223. These pieces of information are output to the user terminal 20a to 20c, and are notified to the users.

The group exclusive page preparation unit 224h sets the URL according to the request for the preparation of the exclusive group purchasing website 163, and creates the hypertext 223f to build up the exclusive group purchasing website 163 (corresponding to a group exclusive page preparation unit of the present invention). The created hypertext 223f is stored into the memory unit 223.

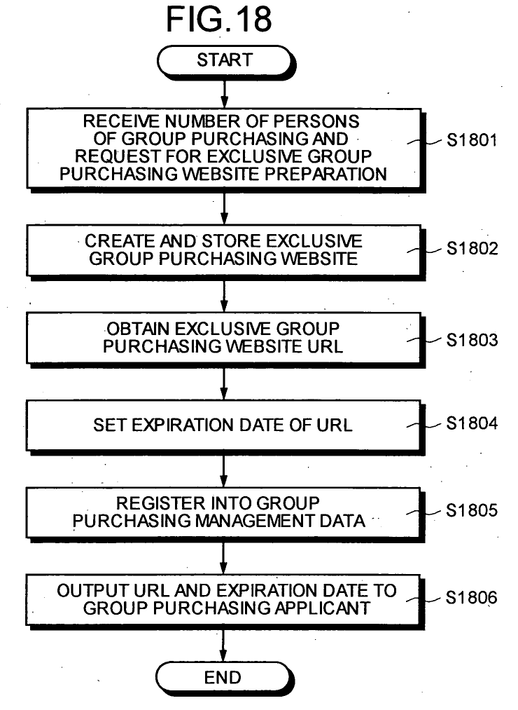

FIG. 18 is a flowchart of the preparation processing of the exclusive group purchasing website carried out by the group purchasing management unit 224b, the identification information issuing unit 224c, and the group exclusive page preparation unit 224h shown in FIG. 17.

The identification information issuing unit 224c receives the information about the number of persons who carry out the group purchasing, and the request for the preparation of the exclusive group purchasing website 163 that are transmitted from the user terminal 20a to 20c (step S1801).

The group exclusive page preparation unit 224h creates the exclusive group purchasing website 163 that only the users belonging to the group can access, and stores the website as the hypertext 223f into the memory unit 223 (step S1802).

Then, the identification information issuing unit 224c obtains the URL of the exclusive group purchasing website 163 from the group exclusive page preparation unit 224h (step S1803), and sets the expiration date to the URL (step S1804).

The group purchasing management unit 224b registers the information about the URL and the expiration date into the group purchasing management data 223d of the memory unit 223 (step S1805). The identification information issuing unit 224c outputs the information about the URL and the expiration date to the user terminal 20a to 20c that transmits a request for the preparation of the exclusive group purchasing website 163, and notifies the information to a user (step S1806).

The user receives the notification, and notifies the information to other users in the group who carry out the group purchasing, by e-mail or the like. These users can access the exclusive group purchasing website 163 by assigning the URL notified.

As described above, according to the third embodiment, the exclusive group purchasing website 163 for the group of persons who carry out the group purchasing is created. The URL is notified to only the users who belong to the group. The users who receive the notification can access the exclusive group purchasing website 163 by assigning the URL. Therefore, the users can efficiently carry out the product purchasing procedure by utilizing the group exclusive website.

In the above three embodiments, the identification information to identify the group purchasing by the group and the expiration date are output to a user terminal apparatus 20a to 20c of the user who applied for the group purchasing. The user notifies the received information to other users in the group. It is also possible to arrange such that a plurality of users who carry out the group purchasing are assigned in advance. When the group purchasing service providing apparatus receives the product purchasing procedure request from the assigned users, the apparatus carries out the product purchasing procedure.

In the fourth embodiment, a process procedure in which the group purchasing service providing apparatus receives the product purchasing procedure request from the users assigned in advance in the group who carry out the group purchasing, and the apparatus carries out the product purchasing procedure is explained. It is assumed that the registration of the users who carry out the group purchasing ended already, and user IDs are already allocated to the users in advance.

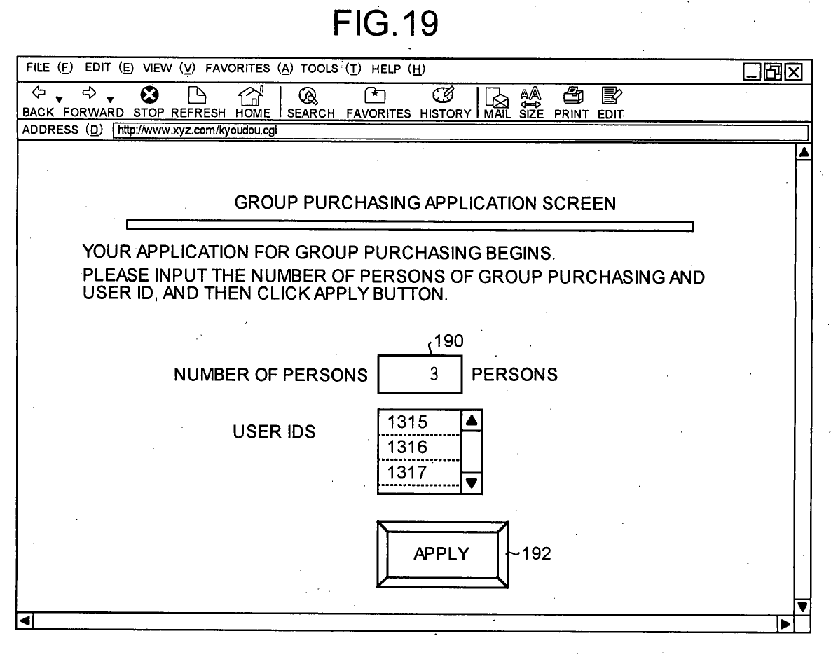

FIG. 19 is a schematic diagram of an example of a display screen for receiving the group purchasing application request at the time of assigning purchasers who carry out a group purchasing in advance. The screen has a number input form 190 in which the number of persons in the group who carry out the group purchasing is input, a user ID input form 191 in which user IDs of the users who belong to the group is input, and an application button 192 that is used to make application for the group purchasing.

The screen shown in FIG. 19 is different from the display screen of receiving the group purchasing key issuing request shown in FIG. 10 in that the user ID input form 191 is additionally provided. By utilizing the user ID input form 191, the apparatus receives the input of the IDs of the users who carry out the group purchasing.

When the group purchasing service providing apparatus receives the access request including the user IDs from the assigned users, the apparatus outputs a message to the user terminal of the users to inform the users that they can now carry out the group purchasing. The group purchasing service providing apparatus receives the product purchasing procedure request from the users who respond to the message, and carries out the purchasing procedure processing for these users. It is not always necessary to output the message to urge the users to carry out the group purchasing. The apparatus can carry out the discount calculation for the group purchasing according to the present invention, without confirming the intention of the assigned users.

The configuration of the group purchasing service providing apparatus according to the fourth embodiment is substantially similar to that shown in FIG. 2. A difference between the two configurations is explained with reference to the functional block diagram illustrating the configuration of the group purchasing service providing apparatus shown in FIG. 2.

In the group purchasing service providing apparatus 22 according to the fourth embodiment, the group purchasing management unit 224b receives the group purchasing application request from the user terminal 20a to 20c of the users together with the user IDs, and registers the user IDs into the group purchasing management data 223d (corresponding to the identification information storing unit and the message transmitting unit according to the present invention).

The group purchasing service providing apparatus receives the access request including the user IDs from the users. When the received IDs coincide with the registered IDs, the apparatus transmits the message to urge the group purchasing to the user terminal 20a to 20c of the users.

The product purchasing payment processing unit 224d receives the product purchasing procedure request according to the group purchasing from the user terminal 20a to 20c of the users, specifies the group purchasing of the group based on the IDs of the users, and carries out the payment processing of the group purchasing.

As described above, according to the fourth embodiment, when the group purchasing service providing apparatus receives the group purchasing application request, the apparatus obtains and stores the user IDs of a plurality of users who carry out the group purchasing. When the apparatus receives the product purchasing procedure request from the users corresponding to the user IDs, the apparatus carries out the purchasing procedure. Therefore, the users can carry out the product purchasing procedure efficiently by only accessing the website using the user IDs.

While the user IDs are used to identify the users, the identification method is not limited to this. It is also possible to use user e-mail addresses or the like to identify the users.

Having described exemplary embodiments of the present invention, it should be understood that the invention can be embodied by various embodiments other than the described embodiments, without departing from the technical spirit throughout the whole documents.

According to the embodiment of the present invention, the identification information that identifies the group purchasing of a group is transmitted to only the user terminal of the users who make the group purchasing application. Instead of this method, it is also possible to use the following method. At the time of receiving the group purchasing application, the group purchasing service providing apparatus obtains information that specifies a transmission destination such as e-mail addresses of the users belonging to the group who carry out the group purchasing. The apparatus may transmit the identification information to the user terminal of the users by e-mail or the like.

According to the embodiment of the present invention, a product is once sold to a user at a normal price without a discount. The price discount is carried out in the payback processing after the reception processing of the product purchasing procedure request for all the users ends. Instead of this method, the product may be sold to users at a discount price from the beginning. With this arrangement, the users can enjoy the merit of discount at an earlier stage.

In this case, one or more users who applied for the group purchasing may not purchase the product, and therefore, may be against the agreement with the sales store of the product. At this time, the sales store may impose a penalty on the users who are against the agreement, by making them pay a penalty charge, for example.

According to the embodiment of the present invention, the number of persons who carry out the group purchasing is assigned in advance at the time of making the group purchasing application. It is also possible to arrange such that any number of persons can participate in the group purchasing, without specifying the number of persons. With this arrangement, the users can obtain the merit of obtaining a high discount rate by increasing the number of participants in the group purchasing even after making the group purchasing application. The sales store of the product can also obtain the merit of increasing the number of products sold.

According to the embodiment of the present invention, the expiration date is set with respect to the identification information to identify the group purchasing of the group. Instead of setting the expiration date, the group purchasing service can also be provided. In this case, even if some users in the group do not purchase the product, the product sales store has no damage as the shop sells the product to other users at the normal price without a price discount.

According to the embodiment of the present invention, the price discount is carried out when the users purchase the product by the group purchasing. Instead of this method, the price discount may not be carried out for the product of a scarcity value. The users can obtain the product of the scarcity value based on the group purchasing. Therefore, the product sales store can sufficiently promote the selling without a price discount.

In each processing in the embodiments of the present invention, the whole or a part of the processing that is explained to be automatically carried out can be processed manually. Similarly, the whole or a part of the processing that is explained to be manually carried out can be processed automatically. The processing procedures, control procedures, detailed names, various kinds of data and parameters shown in the document and in the drawings can be optionally changed except where specified otherwise.

The constituent elements of the apparatuses shown in the drawings show concepts of the functions, and they need not be physically configured as illustrated in the drawings. In other words, distributed or integrated detailed parts of the apparatuses are not limited those shown in the drawings. The whole or a part of these parts can be functionally or physically distributed or integrated in optional units according to various kinds of loads and using states.

The whole or an optional part of the processing functions of each apparatus is realized by a CPU or a program that is analyzed and executed by the CPU, or is realized as hardware by a wired logic.

The group purchasing service providing method explained in the embodiments of the present invention can be realized when a personal computer or a workstation or the like executes a program created in advance.

The program can be distributed via a network such as the Internet. The program can be recorded onto a computer-readable recording medium such as a hard disk, a flexible disk (FD), a CD-ROM, a magneto optical (MO) disk, and a digital video disk (DVD). The computer can execute the program by reading it from the recording medium.

As explained above, according to one aspect of the present invention, it is possible to obtain a group purchasing service providing apparatus capable of efficiently providing a group purchasing service to the users who want to obtain the product at an early date.

According to another aspect of the invention, it is possible to obtain a group purchasing service providing apparatus capable of efficiently providing a group purchasing service to the users who wish to quickly obtain a product different from products of other users.

According to still another aspect of the invention, it is possible to obtain a group purchasing service providing apparatus capable of efficiently shipping products to the users who wish to obtain the products quickly.

According to still another aspect of the invention, it is possible to obtain a group purchasing service providing apparatus capable of providing a group purchasing service for selling a product at a discount price corresponding to the number of users.

According to still another aspect of the invention, it is possible to obtain a group purchasing service providing method capable of efficiently providing a group purchasing service to the users who wish to obtain the product quickly.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An apparatus for providing a group purchasing service, comprising:
an identification information issuing unit that issues, upon receiving a group purchasing application request for a product from a user terminal, user identification information corresponding to the group purchasing application request; and
a product purchasing execution unit that executes, upon receiving a purchasing procedure request for a product from the user terminal with the user identification information issued, a product purchasing procedure for a user who made the purchasing procedure request, and sets the user as an object user for the group purchasing processing corresponding to the user identification information.

2. The apparatus according to claim 1, wherein the product purchasing execution unit executes, upon receiving a group purchasing procedure request for a different kind of product based on the group purchasing with the user identification information from the user terminal, the product purchasing procedure for a user who made the group purchasing procedure request.

3. The apparatus according to claim 1, further comprising:
an identification information transmitting unit that transmits the user identification information issued from the identification information issuing unit to the user terminal, wherein
the product purchasing procedure execution processor receives the product purchasing procedure request with the user identification information transmitted.

4. The apparatus according to claim 1, wherein the identification information issuing unit receives a group purchasing application request indicating a group purchasing of a product for a predetermined number of persons from the user terminal.

5. The apparatus according to claim 1, further comprising:
a shipping processing request unit that makes a processing request for shipping a product to a user who uses the user terminal when the product purchasing execution unit executed the product purchasing procedure.

6. The apparatus according to claim 1, further comprising:
a discount amount calculating unit that calculates, after the product purchasing execution unit completes execution of the product purchasing procedure for each user, a discount amount for a product to be paid back to the user corresponding to number of the object users for the group purchasing processing; and
a discount amount output unit that outputs the discount amount calculated.

7. The apparatus according to claim 6, wherein
the discount amount calculating unit calculates a credit point as the discount amount, and
the discount amount output unit outputs the credit point calculated.

8. The apparatus according to claim 6, wherein the discount amount calculating unit calculates the discount amount based on a destination area for shipping each product.

9. The apparatus according to claim 1, wherein the identification information issuing unit issues a uniform resource locator of last page of either of the processing of the group purchasing application request and the purchasing procedure request.

10. The apparatus according to claim 1, further comprising:
an exclusive page creating unit that creates a website exclusive for a group carrying out the product purchasing procedure, wherein
the identification information issuing unit issues a uniform resource locator of the website created as the user identification information.

11. The apparatus according to claim 1, further comprising:
an identification information storing unit that stores, upon the identification information issuing unit receiving a group purchasing application request for a product including at least a plural pieces of user identification information to identify a plurality of users, respectively, the user identification information of the users; and
a message transmitting unit that transmits, upon the apparatus receiving an access from a user terminal of the users whose user identification information is stored in the identification information storing unit, a message to urge the users to carry out the group purchasing to the user terminal, wherein
the product purchasing execution unit sets, upon receiving a product purchasing procedure request in response to the message transmitted, users who made product purchasing procedure request as object users for the group purchasing processing corresponding to the user identification information.

12. The apparatus according to claim 1, further comprising
an expiration date creating unit that creates an expiration date of the user identification information issued by the identification information issuing unit, wherein
the product purchasing execution unit sets, upon receiving the product purchasing procedure request with the user identification information, a user who made the purchasing procedure request as the object user for the group purchasing processing corresponding to the user identification information, if the expiration date of the user identification information is valid.

13. The apparatus according to claim 1, further comprising
a user information management unit that manages information on each user included in the product purchasing procedure request by associating the information with the group who made the group purchasing application.

14. A method for providing a group purchasing service, comprising:
receiving a group purchasing application request for a product from a user terminal;
issuing user identification information corresponding to the group purchasing application request;
receiving a purchasing procedure request for a product from the user terminal with the user identification information issued;
executing a product purchasing procedure for a user who made the purchasing procedure request; and
setting the user as an object user for the group purchasing processing corresponding to the user identification information.

15. The method according to claim 14, further comprising:
transmitting the user identification information issued from the identification information issuing unit to the user terminal.

16. The method according to claim 14, further comprising:
requesting a processing for shipping a product to a user who uses the user terminal when the executing executed the product purchasing procedure.

17. The method according to claim 14, further comprising:
calculating, after execution of the product purchasing procedure for each user is completed, a discount amount for a product to be paid back to the user corresponding to number of the object users for the group purchasing processing; and
outputting the discount amount calculated.

18. The method according to claim 14, wherein the issuing includes issuing a uniform resource locator of last page of either of the processing of the group purchasing application request and the purchasing procedure request.

19. The method according to claim 14, further comprising:
creating a website exclusive for a group carrying out the product purchasing procedure, wherein
the issuing includes issuing a uniform resource locator of the website created as the user identification information.

20. A computer-readable recording medium that stores a computer program for realizing a group purchasing service on a computer, the computer program making a computer execute:
receiving a group purchasing application request for a product from a user terminal;
issuing user identification information corresponding to the group purchasing application request;
receiving a purchasing procedure request for a product from the user terminal with the user identification information issued;
executing a product purchasing procedure for a user who made the purchasing procedure request; and
setting the user as an object user for the group purchasing processing corresponding to the user identification information.
